(19) United States
(12) Patent Application Publication
(10) Pub. No.: US 2025/0037496 A1
(43) Pub. Date: Jan. 30, 2025

(54) SYSTEMS AND METHODS FOR PLOTTING MARINE LIFE AND MARINE OBSTRUCTIONS

(71) Applicant: Melinda Beth Sokoloski-Dunham, Quincy, MA (US)

(72) Inventor: Melinda Beth Sokoloski-Dunham, Quincy, MA (US)

(21) Appl. No.: 18/786,803

(22) Filed: Jul. 29, 2024

Related U.S. Application Data
(60) Provisional application No. 63/515,871, filed on Jul. 27, 2023.

(51) Int. Cl. G06V 40/10; G06V 10/82; G06V 20/05; G06V 20/17

(52) U.S. Cl. CPC G06V 40/10; G06V 10/82; G06V 20/05; G06V 20/17; G06V 2201/07

(57) ABSTRACT

A method for identifying and tracking objects includes detecting a marine object to be cataloged. The method also includes capturing identifying data for the marine object from one or more sensors on an aerial drone. The method includes analyzing the identifying data to classify the marine object. The method includes storing a classification of the marine object and the identifying data in an archival catalog.

### CROSS-REFERENCE TO RELATED APPLICATIONS

This application claims the benefit of priority of U.S. provisional application No. 63/515,871, filed Jul. 27, 2023, titled “SYSTEMS AND METHODS FOR PLOTTING MARINE LIFE AND MARINE OBSTRUCTIONS” the entire contents of which are herein incorporated by reference.

### FIELD

The present disclosure relates to object detecting, tracking, and recording systems.

### BACKGROUND

Currently, marine observation is done by humans on boats using binoculars or other types of visual enhancement devices. Because humans are visually determining the objects, the identification of marine life is dependent on guesswork. Additionally, the territory covered by the observations is limited by the visual range of the observer and the range of the boats with the human observers.

As can be seen, there is a need for systems and methods that address the above drawbacks.

### SUMMARY

In one aspect of the present disclosure, a method for identifying and tracking objects includes detecting a marine object to be cataloged. The method also includes capturing identifying data for the marine object from one or more sensors on an aerial drone. The method includes analyzing the identifying data to classify the marine object. The method includes storing a classification of the marine object and the identifying data in an archival catalog.

### BRIEF DESCRIPTION OF THE DRAWINGS

FIG. 1 is a diagram of a marine environment that includes a marine cataloging system, according to aspects of the present disclosure;

FIG. 2 is a block diagram of the marine cataloging system, according to aspects of the present disclosure;

FIG. 3 is a logical diagram of processes of the marine cataloging system for plotting marine life and obstructions for the purpose of wildlife preservation and protection, according to aspects of the present disclosure;

FIG. 4 is a data flow diagram of a process for plotting marine life and obstructions for the purpose of wildlife preservation and protection, according to aspects of the present disclosure;

FIG. 5 is a flowchart of a process for plotting marine life and obstructions for the purpose of wildlife preservation and protection, according to aspects of the present disclosure; and

FIG. 6 is a diagram of a graphical user interface generated by the marine cataloging system, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

Broadly, an embodiment of the present disclosure provides a system and method for plotting marine life and obstructions/construction both manually and automatically via object tracking. The system and method can be used in conjunction with current vessel-based observational marine plotting. The system and method can parse information of marine life and obstructions/constructions automatically generated by aerial platforms. The system and method can also parse information of marine life and obstructions/constructions manually generated from visual manifestations of marine life and constructions.

The system and method can tag, label, or both the parsed information and create catalogued datasets. The cataloged datasets can be used as historical references, an a-priori source of information, or training datasets for training a statistical-based algorithm. The cataloged datasets can be curated to include tagged observation data, labeled observation data, classification data, categorization data, location data, time stamp data, one or more rule sets, definitions, miscellaneous user-provided data, or any combinations thereof. The datasets can be stored and made available to select individuals. The datasets can be stored in a cloud-based solution and made available through cloud-based application services. The datasets can be further curated or developed based on input from many different sources.

Accordingly, the system and method provide the ability to image anomalies from a nadir position as opposed to the current use of binoculars onboard survey vessel. Additionally, the system and method of manual and automated flights using drones that use object recording to find patterns indicative of marine life highlighted but not limited to the Marine Protected Species Act. The use of manual and automated flight patterns heightens the probability of spotting and observing marine life being jeopardized by marine vessel traffic and marine construction. The cataloging aspect of the process is made to create information specific to the end user. This means that information can be shared or kept private as they see fit.

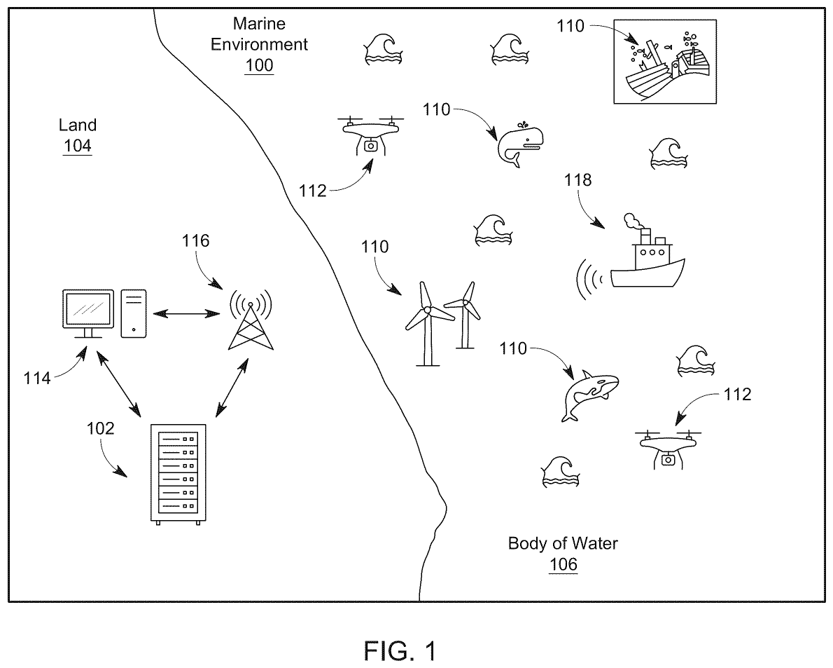

Referring now to FIGS. 1-6, FIG. 1 illustrates a marine environment 100, including a marine cataloging system 102, according to aspects of the present disclosure. While FIG. 1 illustrates examples of components of a marine environment, additional components can be added and existing components can be removed and/or modified.

As illustrated in FIG. 1, the marine environment 100 can include land 104 with an adjacent body of water 106. While marine environment 100 illustrates one piece of land 104 and one body of water 106, one skilled in the art will realize that this is an example and the marine environment 100 can include multiple pieces of land and multiple bodies of water. In embodiments, the body of water 106 can include one or more marine objects 100 that may need to be identified and tracked. The marine objects 110 can include wildlife (e.g., fish, whales, turtles, purposes, coral reefs, etc.) or marine structures (e.g., sunken ships, pipelines, archaeological sites, etc.). The marine objects may need to be tracked for a variety of reasons, for example, to track and protect wildlife.

In embodiments, the marine cataloging system 102 can be utilized to detect, identify, classify, and track the marine objects 110. For example, the marine cataloging system 102 used to create a catalog of marine animals within the limits of the wind turbine construction corridor, thereby creating a safe environment for protected species they must be spotted and avoided to maintain the health of the animal.

In embodiments, the marine cataloging system 102 can communicate with and/or control one or more small unmanned aerial vehicles (sUAVs) 112 that can be used to collect identifying data for the one or more marine objects 110. The UAVs can include one or more sensors that capture the identifying data for one or more marine objects. The one or more sensors can include one or more cameras that can capture images and/or video at various wavelengths (e.g., visible light, infrared, etc.), one or more global positioning system (GPS) sensors to identify a location of the sUAVs 112, one or more motion sensors (e.g., gyroscopes, accelerometers, force sensors, etc.), one or more clock or timers, one or more microphones, one or more climate sensors (e.g., temperature sensors, atmospheric pressure sensors, etc.), and the like.

In embodiments, the sUAVs 112 can be controlled by the marine cataloging system 102. Additionally, the sUAVs 112 can be controlled using a drone controller 114. The drone controller 114 can include any type of remote computing device that communicates with the sUAVs 112 via one or more wireless communication channels 116 (e.g., radio frequency communication channels). An operator can control the sUAVs 112 via the drone controller 112. In embodiments, the sUAVs can be commanded to perform automated flights by the marine cataloging system 102 and/or the drone controller 114. For example, the sUAVs 112 can be programmed with a flight path and/or flight area. In response, the sUAVs 112 can execute the flight path and/or perform a random flight pattern around the flight area capturing identifying data. In some embodiments, the automated flight path and/or flight pattern can be based on migration/movement patterns of wildlife.

In embodiments, the marine cataloging system 102 can also communicate with other sensors and data sources 118 to capture additional data to identify and classify the marine objects 110. The other sensors and data sources 118 can include human sources. The other sensors and data sources 118 can include other marine sensors such as stationary or mobile sonar arrays, stationary or mobile climate arrays, stationary or mobile imaging devices, and the like.

In embodiments, the operator (operator) can be used as a resource for data collection for a client team (client) using the marine cataloging system 102. At the client's request via the marine cataloging system 102, the operator can fly the sUAV 112 to a point of interest determined by the client and perform measurements of the local region using one or more of the sensors. The collected identifying data (primary data and any metadata) can be presented as a data stream, via the marine cataloging system 102, to clients appropriately capable HID for data consumption and data annotation.

For example, the operator can fly the sUAVs 112 manually and look at an area potentially containing marine objects 110, e.g., suspected animal activity. Likewise, the sUAVs 112 can also be flown on automatic missions and use object tracking to identify shapes and import the data to the marine cataloging system 102. The drone controller 114 of the drone will create a longitude and latitude marker. The operator can also enter the information provided by the viewfinder that is mounted on the drone. The marine cataloging system 102 can then process the identifying data using key tags and metadata. The marine object 110 can also be plotted on a map identifying the location of the marine object 110 along with the classification of the marine object and any annotations.

This information is stored on a data storage system of marine cataloging system 102 that is accessible by engineers and Scientists. The marine cataloging system 102 can generate graphical user interfaces (GUIs) that present collected data that can be manipulated and annotated. The GUIs can include a map that can be populated and geo-referenced.

While the purpose of the marine cataloging system 102, is for marine observation, the marine cataloging system 102 can be used in areas where unmanned aerial vehicles could be utilized. The marine cataloging system 102 can be used for plotting and annotating, so, for instance, it could be where there are vast amounts of land and items needing to be monitored. For example, the marine cataloging system 102 can be used for tracking cattle ranches, horse farms, and human crowd counting.

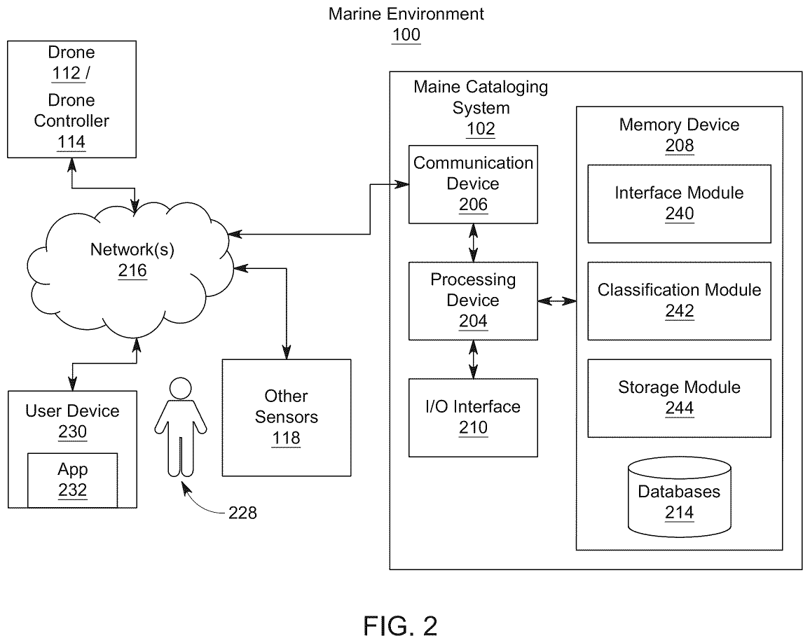

FIG. 2 illustrates the components of the marine cataloging system 102, according to aspects of the present disclosure. While FIG. 2 illustrates examples of components of a marine cataloging system, additional components can be added and existing components can be removed and/or modified.

As illustrated in FIG. 2, the marine cataloging system 202 includes a processing device 204 coupled to a communication device 206. The processing device 204 is also coupled to a memory device 208, and an input/output (“I/O”) interface 210. In embodiments, the communication interface 206 enables the marine cataloging system 102 to communicate with other devices and systems via one or more networks 216. The marine cataloging system 102 can communicate with the drone 112 and/or the drone controller 114. The marine cataloging system 102 can also communicate with the one or more sensors 118. In embodiment, the marine cataloging system 102 can also communicate with a user 228, operating a user device 230, via the network 216. The user device 230 can include one or more electronic devices such as a laptop computer, a desktop computer, a tablet computer, a smartphone, a thin client, and the like.

To perform the process described herein, the marine cataloging system 102 can store and execute an interface module 240, a classification module 242, and a storage module 244 to perform the processes and methods described herein. The interface module 240, the classification module 242, and the storage module 244 can be stored in the memory device 208. The interface module 240, the classification module 242, and the storage module 244 can include the necessary logic, instructions, and/or programming to perform the processes and methods described herein. The interface module 240, the classification module 242, and the storage module 244 can be written in any programming language.

The memory device 208 can also include a database 114 that stores information and data associated with the process and methods described herein. The database 114 can store the data captured by the marine cataloging system 102 and an archival catalog of the marine objects 110. The database 114 can also store base images and/or image templates to be used by the classification module 242. For example, the base images and/or image templates can be generalized images/videos of different types of marine objects. In another example, the base images and/or image templates can be images/videos of specific marine objects, such as tagged and tracked wildlife, known obstructions, etc. The database 114 can be any type of database, for example, a hierarchical database, a network database, an object-oriented database, a relational database, a non-relational database, an operational database, and the like. While FIG. 2 illustrates one database 214, the marine cataloging system 202 can include multiple databases and/or communicate with one or more remote databases.

The classification module 242 operates to classify the marine objects 110 using the indemnifying information captured by the sUAVs and other sensors 118. In embodiments, the classification module 242 can include one or more artificial neural networks that are trained to identify the marine objects 110. The one or more artificial neural networks can use machine learning models that are trained to classify the marine object 110 based on the identifying data. In embodiments, the machine learning models can include object identification models that are trained using marine object data sets, for example, the base and template images/video. As such, the object identification models can be fed the identifying information captured by the sUAVs 112 and other sensors 118 and the tagging data and output an identification of the marine object 110, for example, a general identification (e.g., whale) and/or a specific identification (e.g., tagged Whale—Shamu). In embodiments, the machine learning model can also include motion models that are trained to predict and map marine wildlife movement and migration, for example, historical movement patterns for different types of wildlife. As such, the motion models can be fed the location, position, and motion information, over time, captured by the sUAVs 112 and other sensors 118 and the tagging data and output a predicted movement patter for wildlife.

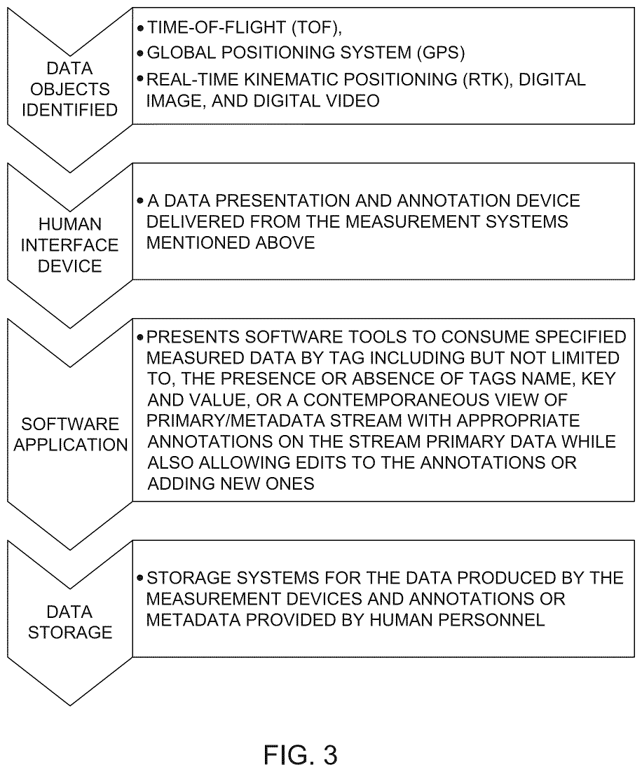

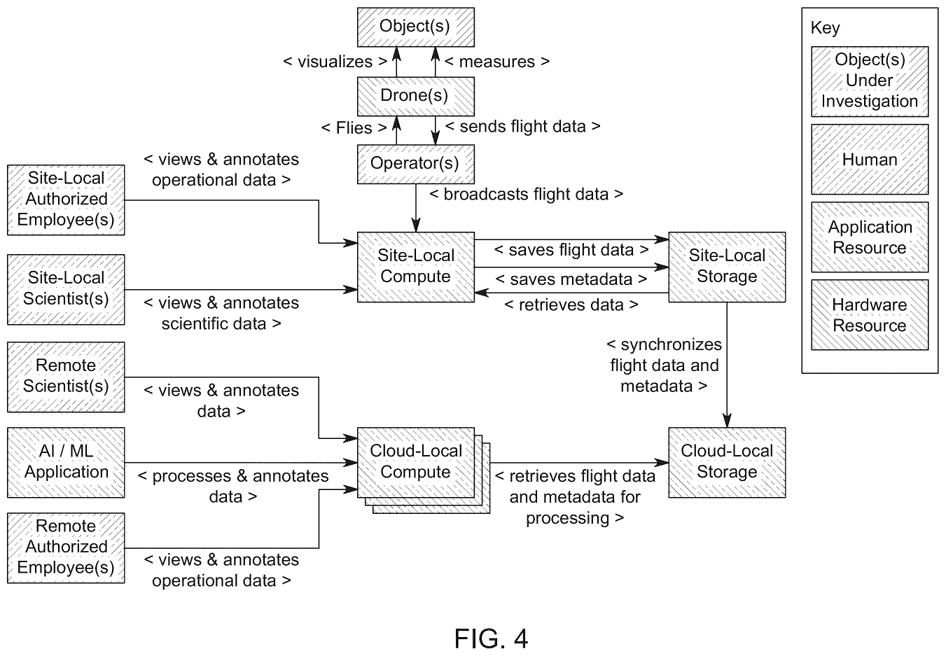

FIGS. 3, 4, and 5 illustrate the process that can be performed by the marine cataloging system 102. While FIGS. 3, 4, and 5 illustrate data flows and stages, additional data flows and stages can be added and/or existing data flows and stages can be modified or removed. Examples of specific exchanges of information can be found in FIG. 4.

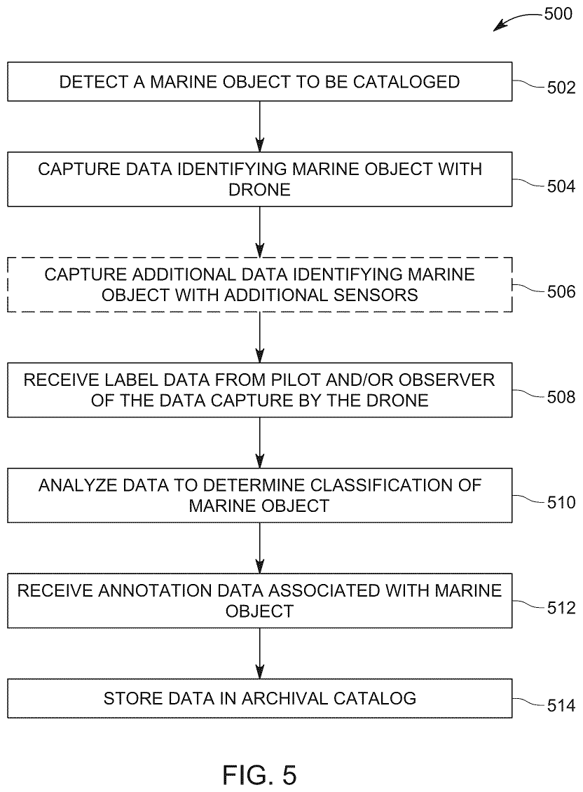

As illustrated in FIG. 5, for example, in stage 502, a marine object to be cataloged can be detected. For example, a client can request that an area of the body of water 106 be surveyed to determine marine objects 110. One or more of the sUAVs 112 can be launched to survey the area. As the sUAVs 112 survey the area, the sensors of the sUAVs 112 can detect a marine object 110. Likewise, the operator of the sUAVs 112 may detect a marine object 110.

In stage 504, the sUAVs 112 can capture data identifying the marine object 110. For example, the sUAVs 112 can capture images, video, position data, climate data, and the like. Optionally, in stage 506, additional data identifying the marine object 110 can be captured using the additional sensors, e.g., the other sensors and data sources 118. In stage 508, label data can be received from the operator of the sUAVs 112 or an observer of the operation of the sUAVs 112.

In stage 510, the identifying data can be analyzed by the marine cataloging system 102 to classify the marine object 510. For example, the marine cataloging system 102 can utilize one or more artificial neural networks that can use machine learning models that are trained to classify the marine object 110 based on the identifying data.

In stage 512, annotation data can be received to be associated with the marine object 110. For example, the engineers and/or scientists can provide annotation data that provides further information on the marine object 110. In stage 514, the classification of the marine object 110 and the identifying information can be stored in an archival catalog.

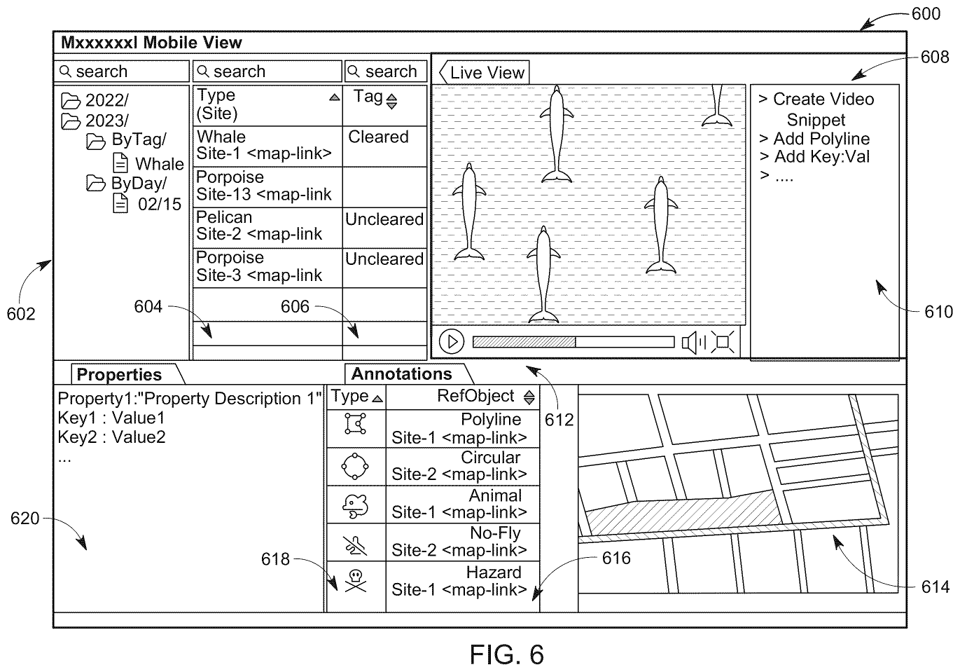

The interface module 240 operates to generate and provide graphical user interfaces (GUIs), for example, menus, widgets, text, images, fields, etc., the access the data captured and generated by the marine cataloging system 102. FIG. 6 illustrates one example of a GUI 600. The GUI 600 can include a viewing window 608 that shows video and or images captured by the sUAVs 112. The video and or images can be live real-time video and/or images. The video and or images can be also be previously captured video and/or images. The GUI 600 can include a menu 610 that allows for editing and labeling the video and/or images. The GUI 600 also includes control widgets 612 for controlling playback or viewing video and/or images.

The GUI 600 includes a menu 602 that allows access to archival catalog for an area or the marine object 110. The menu 602 can allow access according to date/time or identifying information of a marine object. The GUI 600 includes a search menu 604 that allows a reference search by multiple values such as marine life, obstruction, and vessels. The GUI 600 also includes a menu 606 that allows a user to review past captures including those that have been tagged manually by the operators of the sUAVs 112.

The GUI 600 can also include a map 614 of the area that includes the identification of the marine object 110. The map 614 can display geographical information and can be presented in longitude and latitude. The map 614 can also include active links to the classification and identifying data of the marine object 110.

The GUI 600 can also include an annotation menu 616 that allows the annotations and/or identifying information of a marine object 100. The menu 616 can include a graphical representation 618 of the label applied by the operator of the sUAVs 112. The GUI 600 can also include a menu 618 that allows the data stored to be sorted by storage indexing.

Returning to FIG. 2, according to the aspects of the present disclosure, the user device 230 can store and execute a copy of an application 232. The application 232 enables the user 228 operating the user device 230, to communicate with and receive the GUIs of the marine cataloging system 102. In some embodiments, the application 232 can be a specifically designed application that operates with the marine cataloging system 102 to perform the processes and methods described herein. In some embodiments, the application 232 can be a third-party application, such as a web browser, that communicates with the marine cataloging system 102 to perform the processes and methods described herein.

The processing device 204, the communication device 206, the memory device 208, and the I/O interface 210 can be interconnected via a system bus. The system bus can be and/or include a control bus, a data bus, an address bus, and the like. The processing device 204 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 2 illustrates a single processing device 204, the marine cataloging system 102 can include multiple processing devices 204, whether the same type or different types.

The memory device 208 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 208. While FIG. 2 illustrates a single memory device 208, the marine cataloging system 102 can include multiple memory devices 208, whether the same type or different types.

The communication device 206 enables the marine cataloging system 102 to communicate with other devices and systems. The communication device 206 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The marine cataloging system 102 can communicate with one or more network resources via the network 216. The one or more network resources can include external databases, social media platforms, search engines, file servers, web servers, or any type of computerized resource that can communicate with the marine cataloging system 102 via the network 216.

In embodiments, the components and functionality of the marine cataloging system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the marine cataloging system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the network environment 100, including the marine cataloging system 102, the drone controller 114, and the user device 230 can include a user interface for outputting information in a format perceptible by a user and receiving input from the user. For example, the marine cataloging system 102 can communicate with the user interface via the I/O interface 212. marine cataloging system 102. The user interface can display graphical user interfaces (“GUIs”) generated by the marine cataloging system 102. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for identifying and tracking objects, comprising:
detecting a marine object to be cataloged;
capturing identifying data for the marine object from one or more sensors on an aerial drone;
analyzing the identifying data to classify the marine object; and
storing a classification of the marine object and the identifying data in an archival catalog.

2. The method of claim 1, further comprising:
receiving label data from an entity piloting the aerial drone, wherein the label data is used to classify the marine object.

3. The method of claim 1, further comprising:
capturing additional data from one or more additional sensors separate from the aerial drone, wherein the additional data is used to classify the marine object.

4. The method of claim 1, further comprising:
receiving annotation data for the marine object from one or more entities; and
storing the annotation data in the archival catalog associated with the marine object.

5. The method of claim 1, wherein the identifying data comprises one or more of images captured by the one or more sensors on the aerial drone, video captured by the one or more sensors on the aerial drone; and positioning data captured by the one or more sensors on the aerial drone.

6. The method of claim 1, wherein analyzing the identifying data to classify the marine object comprises:
applying the identifying data to one or more artificial neural networks that are trained to identify the marine object.

7. The method of claim 1, wherein the classification of the marine object comprises an identification of tagged wildlife.

8. The method of claim 1, wherein analyzing the identifying data to classify the marine object comprises:
predicting movement patterns of the marine object.

9. The method of claim 1, further comprising:
transmitting an automated flight pattern to the aerial drone.

10. The method of claim 1, wherein the automated flight pattern is based on migration/movement patterns of wildlife.
